(19) United States
(12) Patent Application Publication
(10) Pub. No.: US 2004/0156991 A1
(43) Pub. Date: Aug. 12, 2004

(54) Wiper blade accessory containing ablative coating material

(76) Inventors: Brian A. Brown, San Francisco, CA (US); Lloyd Douglas Clark, San Francisco, CA (US)

Correspondence Address: Lloyd Douglas Clark, 15 Conrad St, San Francisco, CA, 94131-2924, US

(21) Appl. No.: 10/771,806

(22) Filed: Feb. 4, 2004

Related U.S. Application Data
(63) Continuation-in-part of application No. 10/224,113, filed on Aug. 19, 2002, now abandoned.
(60) Provisional application No. 60/313,623, filed on Aug. 20, 2001.

(51) Int. Cl. B05D 3/12

(52) U.S. Cl. 427/356; 15/250.01; 118/500

(57) ABSTRACT

A cylindrical dispenser (100) contains a hydrophobic or hydrophilic Surface Treatment Material (STM) (110). The dispenser is attached to a windshield or other wiper blade (500), or attached to a bracket (400), arm (700), or channel (415) associated with the blade. At rest, the dispenser is oriented such that holes (105), a slit (106), or slots (107) normally face downward, keeping the STM dry, even in rain. When the windshield wiper is energized, however, the arm rotates on a pivot (800) and the angle of rotation is sufficient to expose the bottom side of the dispenser to falling rain, thus dissolving a small portion of the STM. The dissolved STM falls onto a vehicle's windshield (900), for example, and is dispersed by the wiping action of the blade. Thus the STM is automatically dispensed only when the wiper blade is in use in wet conditions. The wiping edge of the blade is in contact with a surface (900), such as the vehicle's windshield. As the STM dissolves, it flows or drips from the dispenser onto the windshield where it is forced into intimate contact with the surface by the wiping action of the blade.

### CROSS-REFERENCE TO RELATED APPLICATIONS

This application is a continuation in part of our patent application Ser. No. 10/224,113, filed Aug. 19, 2002, now abandoned, which claims priority of provisional patent application, serial No. 60/313,623, filed Aug. 20, 2001.

### FEDERALLY SPONSORED RESEARCH

None

### SEQUENCE LISTING

None

### BACKGROUND

1. Field of Invention

This invention relates generally to wiper blades and assemblies for wiping or wetting surfaces, and in particular to chemical dispensers for use with such blades and which deposit a substance onto a surface as the blade wipes.

2. Prior-Art

Razors

Disposable safety razors, such as those taught in U.S. Pat. No. 5,956,848 (1999) to Tseng, and manufactured by The Gillette Company of Boston, Mass., USA, have a dissolvable strip containing a wetting agent and vitamin E near the blade assembly. The strip is positioned adjacent and parallel to the blade and, during use, deposits a film on the user's skin and hair. This film enhances the shaving experience by lubricating the blade, thus reducing drag on the skin and hair. The strip material is applied to the user's skin only during shaving and is later rinsed away. While this device works well, it applies to a shaving operation only. It would be of no use in a wiping application, and in fact could cause a wiped surface to be clouded by leaving vitamin E and other chemical residue on the surface.

Windshield Cleaning Solutions

Windshield cleaning solutions are well-known. They are normally supplied in a reservoir with a pump. When the pump is activated, the cleaning solution is forced through nozzles onto a vehicle's windshield. This wetting, combined with the wiping action of windshield wipers, serves to clean the windshield of dirt and debris. However, windshield washing solutions are normally contained in aqueous solutions and hence do not render the surface of the windshield either hydrophobic or hydrophilic. Therefore, these solutions are normally useful only for periodically cleaning the windshield.

Windshield Wiper Blades

When driving in rain, a vehicle operator's vision is obstructed by water droplets on the vehicle's windshield. Oily debris further reduces visibility. Prior-art windshield wiper blades remove water from windshields, and in conjunction with solvents in windshield washers found on most vehicles are able to remove oily debris.

Prior-art coatings, described below, are available to improve visibility through a vehicle's windshield during rain. They either cause water to bead up and blow away as the vehicle is moving, or they cause droplets to flatten out and coat the windshield with a smooth, transparent film. These coatings are applied either manually, at the vehicle factory, or by a prior-art wiper mechanism described below. Applying the coatings manually is often inconvenient since the need for the coating is not apt to be recognized until the vehicle is being driven in the rain. Factory-applied coatings, described below, are expensive. Prior-art windshield wiper blades have heretofore not applied visibility-enhancing coatings to vehicle windshields without requiring external pumps and tubing connections.

Wiper Blade with Fluid Delivery System

In U.S. Pat. No. 4,192,038 (1980), Klein, et al teach a dual-edged (two parallel blades) wiper blade which is used for cleaning and/or coating generally smooth surfaces. Klein's wiper is typically two cm high and 65 cm long. It is preferably made of rubber or a similar flexible material, and is secured in a rigid frame. The blades have two edges, separated about 2 mm, in contact with the surface to be wiped. An arm attached to a pivot urges the edges of the blades into contact with the surface, such as a vehicle windshield. A rigid tube also extends interiorly along the length of blades, between the two edges. The rigid tube contains holes through which a cleaning fluid flows and exits into the space between the edges. A second, flexible tube communicates with a reservoir which contains cleaning fluid. A pump forces fluid from the reservoir, into the flexible tube, and out through holes in the rigid tube.

This system has several disadvantages. The flexible tube connected between the reservoir and the rigid tube inside the blade suffers from exposure to the elements (sun, rain, heat, cold) which militates against the requirement that it be flexible under all conditions. Such tubes are prone to crack, leak, and break over time and must be replaced. The reservoir and the pump required to force the fluid from the reservoir to the holes in the rigid tube add significant cost. One or more of holes in the rigid tube can become clogged with dirt and insect debris and prevent release of the fluid. Further, the user must remember to maintain the level of the fluid in the reservoir, and to activate the pump whenever the cleaning action of the fluid is required.

Wiper Blade with Fluid Delivery System and Sponge

In U.S. Pat. No. 4,745,653 (1988), Bliznak teaches a wiper blade assembly similar to Klein's, supra, with the addition of a sponge.

As with Klein's wiper, this system suffers from numerous disadvantages. It is costly, and prone to failure due to a cracked flexible tube and clogged pores in the sponge. In addition, the user must remember to maintain the fluid level in the reservoir, and to activate the pump whenever cleaning action is required.

Wiper Blade with Central Chamber Containing a Dissolving Agent

In U.S. Pat. No. 3,103,686 (1963), Reynolds teaches a wiper blade with an axial, central hole, or gallery. A solid, dissolvable core of degreasing material resides within the axial chamber in the blade. Numerous radial holes lead from the chamber to the outside edge of the blade. When the blade is wet, water flows through the upper radial holes, across the core material, and out through the lower radial holes. In so doing, the water wets and dissolves the core material and conveys it out through the downhill holes and onto the surface being wiped.

This system suffers from several disadvantages. First, it is difficult to manufacture and its many small radial holes are prone to clogging. Secondly, there is no clear indication of the amount of degreasing material left in the blade. Finally, holes on the uphill side of the blade permit water to flow through the core of the blade, even when the blade is not in use. Thus if the blade is left outside in the rain, the degreasing material will be dissolved and wasted.

Detergent Holder on Windshield Wiper Arm

In U.S. Pat. No. 3,792,506 (1974), Rouse teaches a cylindrical cake of solid detergent held in a fixture which is mounted on a windshield wiper arm.

According to Rouse, the holder has openings on its side facing the windshield and is entirely open on its opposite side for exposure to rain water. Again, this arrangement will permit the detergent cake to dissolve in the rain even though the windshield wiper is not being used. Thus the contents of the detergent cake will be wasted.

De-icer for Windshield Wipers

In U.S. Pat. No. 2,485,025 (1949), Wattles teaches a means for preventing the formation of ice on a windshield wiper blade. He places a salt reservoir containing either granular or solid salt in contact with a wiper blade. He deliberately avoids contact between the salt and the windshield to “avoid the smearing of the glass and the resulting obscurement of vision which has characterized all previous windshield de-icers using salt.” Thus his device applies a salt solution selectively to the wiper blade only, near its point of contact with the windshield.

Wattles's preferred embodiment shows a cartridge containing salt with its opening facing downward and adjacent to the lower side of a wiper blade. An alternative embodiment shows two cartridges containing granular salt through which water can freely flow.

Wattles addresses only the problem of ice on the edge of the wiper squeegee. He does not address ice or dirt on the windshield itself. In fact, he avoids contact between the salt contained in his cartridge and the windshield. “By keeping the salt out of contact with the windshield, I avoid the smearing of the glass and the resulting obscurement of vision which has characterized all previous windshield de-icers utilizing salt.” This device suffers from several deficiencies. While the preferred embodiment shows a salt cartridge open on its downward-facing side, Wattles depends on the salt solution washing laterally across the blade, then “downwardly along the squeegee strip” in order to de-ice the blade at the point of contact with the windshield. Thus, in order for his device to function, the salt cartridge must be in intimate contact with the blade. The device will not function if it is suspended from the wiper arm or other location away from the edge of the blade. Furthermore, if the windshield wiper blade were to become frozen to the windshield, no salt would be dispense since the blade would be frozen in the horizontal rest position, and would not work. The alternative embodiment exposes the salt to rain water even when the vehicle is not in use. This wastes salt and needlessly shortens the life of the device.

Water-Repelling and Water-Binding Compounds for Treating Vehicle Windshields and Other Non-Porous Surfaces

In U.S. Pat. No. 3,579,540 (1971), Ohlhausen teaches a chemical compound which renders windshields water-repellent, i.e., hydrophobic. This compound has been sold under the mark “Rain-X” by Sopus Products, Houston, Tex., USA. When this compound is applied to a vehicle windshield, water forms beads and is removed from the windshield by aerodynamic forces as the vehicle moves, thereby improving visibility. A similar compound is sold under the mark “Castrol Super Clean AccuVision” by Castrol Corporation of Swindon, Wiltshire, UK.

Visibility can also be improved by applying a compound that binds water to the windshield surface, rather than repelling it. Nitrogen-enriched titanium dioxide coatings have been announced by Toyota Central R&D Laboratories, of Nagakute, Japan. These coatings are hydrophilic or wetting, i.e. they attract or bind water in such away that it flattens out into a thin film, thus improving visibility by averting formation of small droplets which appear as a fog.

While these compounds substantially improve visibility when driving through rain, they must be applied to the surface of the windshield before it is wet with rain. It is not always easy for the user to remember to apply such coatings when the need is not present, i.e. when there is no rain. The coatings must also be renewed periodically, requiring more work on the part of the user.

### OBJECTS AND ADVANTAGES

Accordingly, one object and advantage of the present invention is to provide an improved method and apparatus for applying cleaning and protective coatings to vehicle windshields and other non-porous surfaces, and for cleaning windshields and other surfaces. Another object is to provide an improved wiper blade assembly. Further objects are to provide a method and apparatus which applies a hydrophobic or hydrophilic coating to a surface without the requirement for a pump and flexible hose, which is applied automatically without intervention by the user, which can be applied at any time, notably in the rain, which is applied only when windshield wipers are in use, which is not wasted when the windshield wipers are not in use, and which does not have to be applied solely by lateral flow across a wiper blade. Additional objects and advantages will become apparent from a consideration of the drawings and ensuing description.

### SUMMARY

In accordance with a preferred embodiment of the present invention, a cartridge is provided with a chamber which contains a solid or semi-solid volume of Surface Treatment Material (STM). This material preferably comprises a hydrophobic or hydrophilic compound in a matrix which slowly ablates in the presence of water, releasing the STM as the matrix dissolves. Weep holes or slots in a downward-facing side of the cartridge are wetted when the windshield wiper arm swings through its normal arc in the rain, thus supplying the STM with water whenever the blade is wet, and releasing the STM back out through the same holes. Since the weep holes are on the downward-facing side of the cartridge, the STM is not wasted when a vehicle is parked in the rain and its windshield wipers are not in use.

When used on the windshield of a vehicle, the coating improves visibility in the rain by either binding the rain water into a film on the windshield surface (hydrophilic), or causing it to bead (hydrophobic) and be removed by aerodynamic forces. The STM can be applied at any time by simply operating the vehicle's windshield washer.

### DRAWINGS—FIGURES

FIGS. 1A through 1C show top, side, and bottom views respectively of a STM (Surface Treatment Material) container and dispenser with holes on the bottom side in accordance with the invention. FIGS. 1D through 1F show respective end views.

FIGS. 2A and 2B are bottom and end views, respectively, of the dispenser with a longitudinal slot.

FIGS. 3A and 3B are bottom and end views, respectively, of the dispenser with multiple radial slots.

FIGS. 4A and 4B show front and side views of a wiper blade assembly and the dispenser prior to assembly. The dispenser can be any of those shown in FIGS. 1 through 3.

FIGS. 5A and 5B show side and end views, respectively, of the components of the assembly of FIG. 4 in an assembled condition.

FIGS. 6A and 6B show side and end views, respectively, of an alternative mounting position of the dispenser.

FIGS. 7A and 7B show side and end views, respectively, of second and third alternative mounting positions of a plurality of containers and dispensers.

FIGS. 8A and B show the dispenser in the rest and active positions, respectively.

FIG. 9 shows aerodynamically-induced water flow against the bottom of the dispenser in the rest position.

FIGS. 10A and 10B and 11A and 11B show cross-sectional views of two dispensers with varying water paths and partially-depleted STMs.

FIGS. 12 through 14B show alternative embodiments with dispensers mounted at alternative locations.

DRAWINGS-Reference Numerals

| | |
|---|---|
| 100 | Dispenser |
| 105 | Holes |
| 106 | Slit |
| 107 | Slots |
| 108 | Edges |
| 110 | STM |
| 115 | Cap |
| 120 | Crimp |
| 125 | Plug |
| 130 | Clip |
| 400 | Bracket |
| 415 | Channel |
| 500 | Blade |
| 700 | Arm |
| 800 | Pivot |
| 900 | Windshield |
| 910 | Water or solvent |

### DETAILED DESCRIPTION

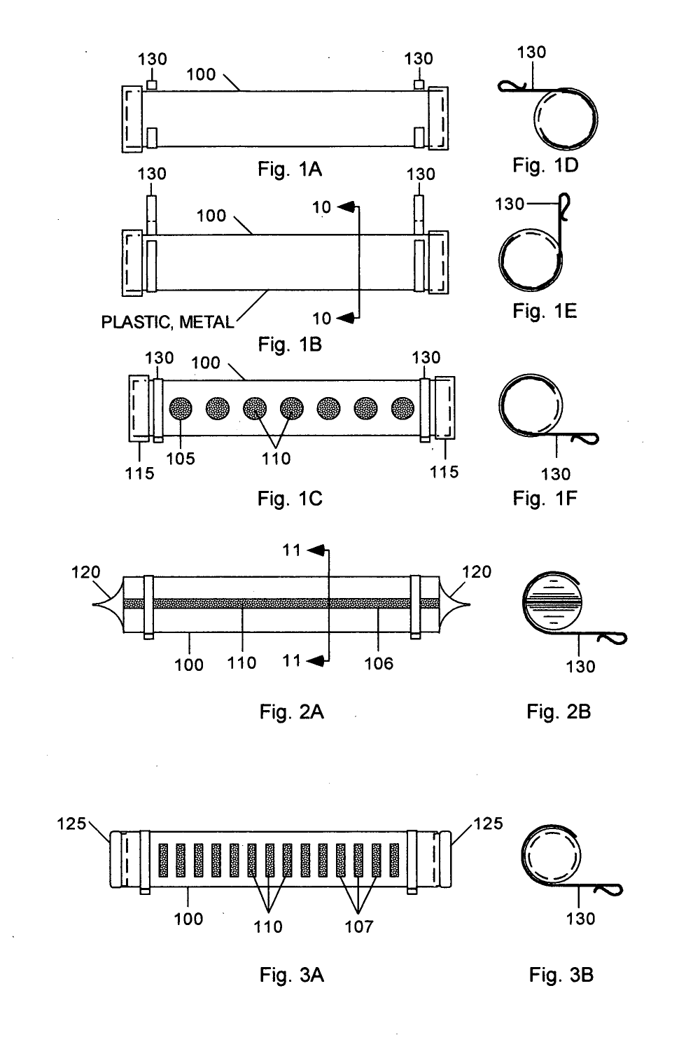

### Preferred Embodiment—FIG. 1 Through 3

FIGS. 1(A-F), 2(A and B), and 3(A and B) show several dispenser cartridges according to the present invention. FIGS. 1(A-F) show a cylindrical dispenser 100 with holes 105, a slit 106 (FIGS. 2A and 2B), slots 107 (FIGS. 3A and B)), or other apertures along its bottom side. The remaining circumference of dispenser 100 is preferably solid, containing no holes.

The diameter, length, and wall thickness of dispenser 100 are preferably 8.25 mm, 10 cm, and 0.75 mm respectively. These dimensions can be made larger or smaller to accommodate various requirements.

Dispenser 100 is preferably made of an inexpensive, extruded plastic such as polyvinyl chloride (PVC), acrylic, polyester, and the like. It can also be made of a metal such as steel, aluminum, or brass, or a high-grade plastic such as polycarbonate.

The ends of dispenser 100 are sealed with end caps 115. Alternatively, the ends of dispenser 100 can be crimped as shown at 120 in FIG. 2, or plugs 125 can be used (FIG. 3). If desired, a combination of capping, plugging, and crimping can be employed.

Dispenser 100 is filled with STM 110, which is visible through holes 105 (FIG. 1C). STM 110 is preferably inserted into dispenser 100 prior to application of at least one of end caps 115, crimps 120, or plugs 125. STM 110 preferably comprises a matrix, slightly soluble in water, containing one or more hydrophobic or hydrophilic surface treatment materials such as alkyl polysiloxane (hydrophobic), nitrogen-enriched titanium dioxide (hydrophilic), and the like. STM 110 can be supplied in many forms, such as a rod, powder, crystals, or liquid. In the case of insertion of a liquid STM, it would preferably be melted, poured into place, then cooled to revert to a solid phase once inside dispenser 100. Alternatively, STM 110 can be co-extruded with dispenser 100 so that dispenser 100 and STM form a coaxial pair. In yet another alternative form, a non-volatile liquid STM 100 can be held in place by an open-pore sponge, and caused to leach from the sponge in the presence of water.

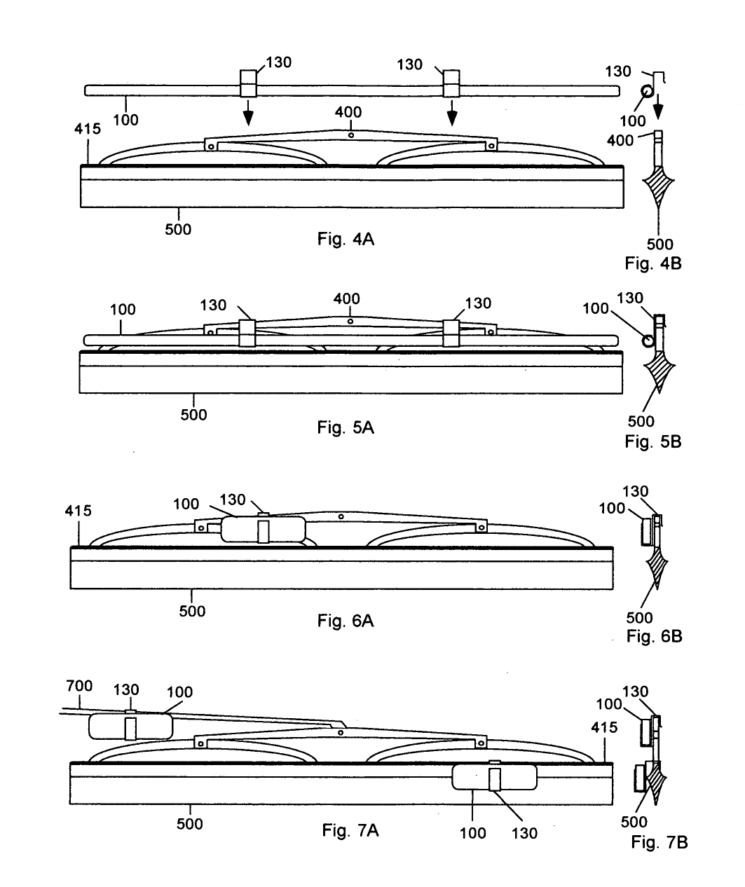

In an alternative formulation, STM 110 is insoluble in water, but soluble in either an organic or inorganic solvent such as alcohol, soluble enzymes, salts, and the like. One or more clips 130 are affixed to dispenser 100. Clips 130 permit attaching dispenser 100 to a windshield wiper bracket 400 or arm 700 (FIG. 6), as shown in FIGS. 4 and 7.

Prior-art wiper blade 500 is typically held in place by a plastic or metal channel 415. Channel 415 is flexibly affixed to bracket 400, which in turn is pivotally affixed to arm 700 (FIG. 7).

Operation—Preferred Embodiment—FIG. 4 Through 9

In preparation for use, dispenser 100 is clipped to bracket 400 (FIG. 4), channel 415 (FIG. 7), or arm 700 (FIG. 7). Multiple dispensers 100 can be affixed to any or all of parts 400, 415, and 700, if desired dispenser 100 is oriented with opening holes 105 (FIG. 1), slot 106 (FIG. 2) or slots 107 (FIG. 3) facing downward and approximately plumb when blade 500 is in its parked position. Arm 700 is attached to pivot 800.

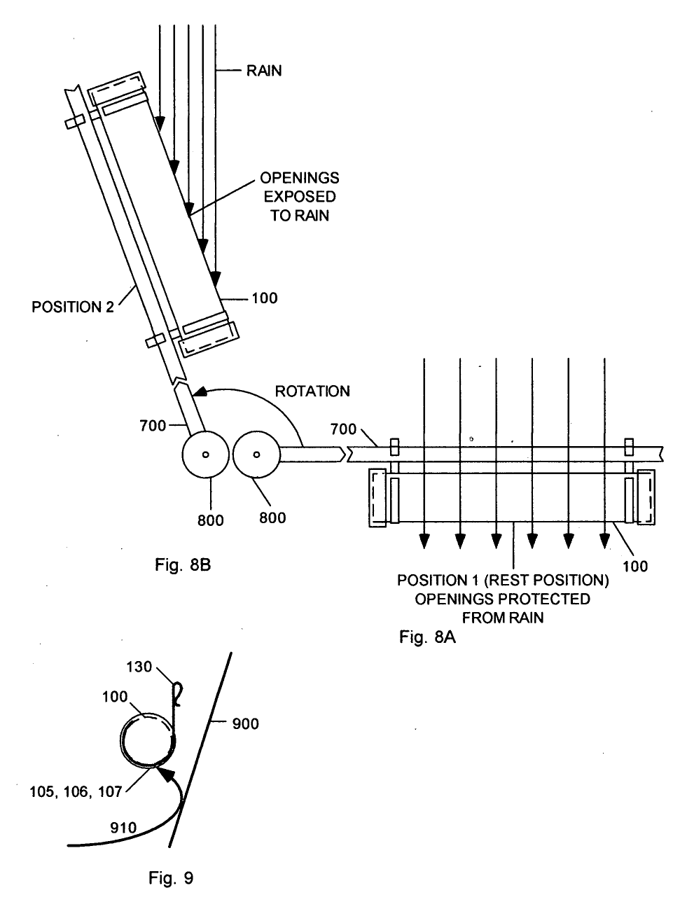

When the windshield wiper is not in use, pivot 800 rotates so that arm 700 is horizontal at Position 1 (FIG. 8A). When the windshield wiper is in use, pivot 800 causes arm 700 to swing in an arc between Positions 1 and 2.

### Wiper Not in Use

When wiper blade 500 is not in use (Position 1), dispenser 100 is oriented horizontally with holes 105, slot 106, or slots 107 facing downward. Water or solvent 910 falling on dispenser 100 will not contact STM 110 and therefore will not cause it to be dispensed from dispenser 100. Thus STM 110 will not be wasted, but will instead be reserved for later use.

### Wiper in Use

When it rains the driver will turn on the windshield wiper, causing wiper blade 500, bracket 400, and arm 700 to execute an arc including more than 90 degrees as blade 500 is moved across the surface being wiped (not shown), such as a windshield 900 (FIG. 9). Since dispenser 100 is affixed to channel 415, bracket 400, or arm 700, it will also execute such an arc. This will cause holes 105, slot 106, or slots 107 to be directly exposed to the rain water falling from above, thus causing STM 110 to be wetted and thus dispensed from dispenser 100.

As the vehicle to which blade 500 is affixed moves forward, aerodynamic forces (shown at 910) will be deflected by windshield 900. This will cause rain water to flow upward against the bottom side of dispenser 100, causing STM 110 to be dispensed (FIG. 9).

Similarly when the vehicle's windshield washing apparatus is activated in dry weather, streams of washing solution will impinge on the bottom side of container 100 as arm 700 sweeps blade 500 through the streams, thus causing STM 110 to be dispensed.

As it is dispensed from container 100, STM 110 will fall randomly on the vehicle's windshield in the path of blade 500. It will eventually be dispersed across the surface of the windshield by the wiping action of blade 500 as it wipes the windshield.

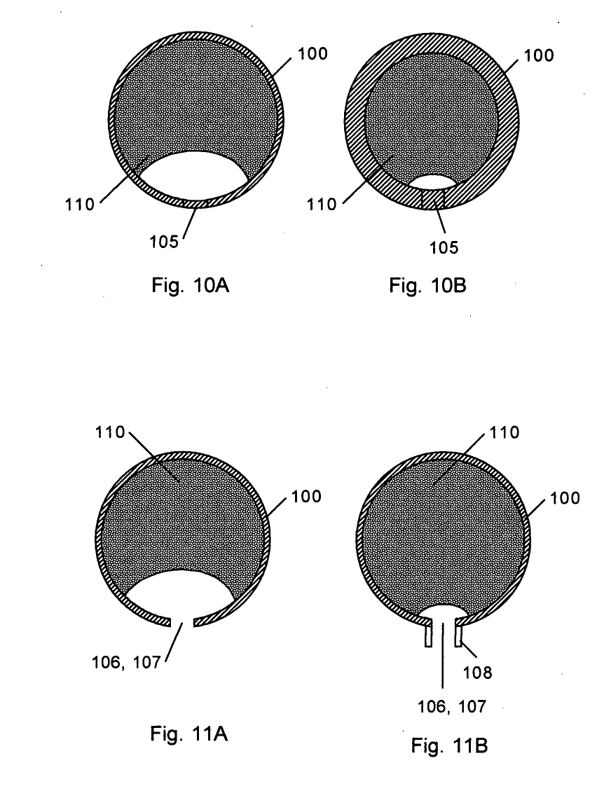

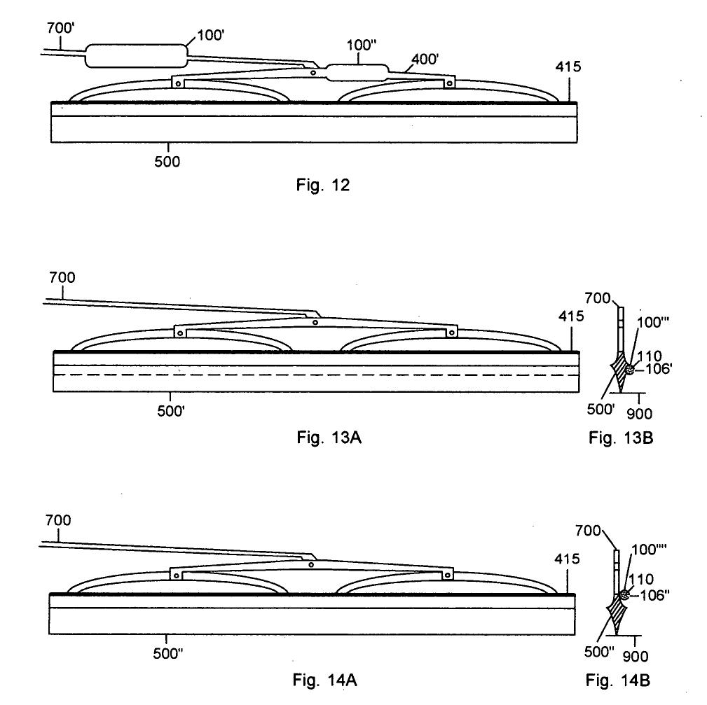

Description—Alternative Embodiments—FIGS. 10 and 11

In the above embodiments, the distance between the outer surface of dispenser 100 and STM 110 is merely the wall thickness of dispenser 100. In order to more fully protect STM 110 from unwanted dispensation, or to reduce the amount dispensed, the embodiments of FIGS. 10B and 11B provide greater distance between the outer surface of dispenser 100 and STM 110.

The greater wall thickness of dispenser 100 increases the distance which must be traveled by rain water in order to cause dispensation of STM 110. This is shown in FIG. 10B. Deeper holes with smaller diameters will slow dispensation, while shallow holes with larger diameters will speed dispensation of STM 110.

In the case of slot 106 or slots 107, edges 108 are added at the opening of slot 106 or slots 107, as shown in FIG. 11B.

In both of the above cases, STM 110 depletes more slowly, leaving a relatively smaller void in STM 110, as the path length for water increases either due to a greater wall thickness of dispenser 100, or edges 108.

Description—Second Alternative Embodiment—FIG. 12

In the embodiment of FIG. 12, dispensers 100′ and 100″ are formed within the structure of the windshield wiper arm or bracket. They comprise a cylindrical region similar to dispensers 100, 120, or 125 as shown above in FIGS. 1 through 3. Holes 105, or slots 106 or 107 are present on the bottoms, as in the case of dispensers 100, 120, and 125.

Description—Third Alternative Embodiment—FIG. 13A, B

In this embodiment, dispenser 100′″ comprises a cylindrical channel 1300 formed on the bottom side of wiper blade 500′. Channel 1300 is preferably formed as blade 500′ is extruded in the course of manufacture. A slit 106′ permits water or washer solvent to reach STM 110 and dissolve it, as in the earlier embodiments. Since slit 106′ is on the bottom side of blade 500′ when blade 500′ is in its parked or rest position, STM 110 will not be wasted when blade 500′ is not in use. STM 110 is dissolved only when blade 500′ is wiping the surface of windshield 900.

Description—Fourth Alternative Embodiment—FIG. 14A, B

This embodiment is similar to that shown in FIGS. 13A and 13B, except a dispenser 100″″ is attached to a channel 415 which holds blade 500″.

Conclusion, Ramifications, and Scope

It is thus seen that the present system provides a novel apparatus and method for applying a surface treatment material to a surface such as a vehicle windshield, headlamps, and the like. A container containing a surface treatment material is affixed to a wiper blade channel, bracket, or arm. Holes or slits which expose the STM to rain water face downward so that the STM is dispensed only when the vehicle is moving forward, or when the windshield wiper is in operation. At all other times, even in rain, the STM remains in the dispenser and is not wasted. The STM matrix is normally solid or semi-solid, and dissolves very slowly in the presence of water or another solvent. Hydrophobic or hydrophilic surface treatments can be applied. No pump or flexible hose is required to deliver cleaning fluid. The STM is applied by the wiping action of the wiper blades. It is automatically renewed each time it is used, without effort on the part of the user.

While the above description contains many specificities, these should not be considered limiting but merely exemplary. Many variations and ramifications are possible. For example, the STM can be attached to or incorporated into a squeegee to apply coatings to windows in buildings as they are washed and dried. Numerous other uses include dispensers for application of coatings to various substrates used in semiconductor manufacture, disks for disk drives, waterproof and stain-proof coatings for marble, and the like. Dispensers comprising cylinders, rods, and disks which clip onto wiper assemblies can be attached by members such as wire, metal or plastic mesh, and the like. The inside of the dispenser can be painted or coated with a bright, contrasting color. This color is normally blocked by the STM, but when the STM is exhausted the color will be visible, providing an indication to the user. At this point, a new, full dispenser is required. A sight glass which permits viewing of the interior of the dispenser can be used to provide an alternative indication of the amount of STM remaining.

While the present system employs elements which are well-known to those skilled in the arts of chemistry and mechanical engineering, it combines these elements in a novel way which produces a new result not heretofore discovered.

Accordingly the scope of this invention should be determined, not by the embodiments illustrated, but by the appended claims and their legal equivalents.

We claim:

1. A device for applying a surface treatment material to a surface that is wiped with a wiper blade having a predetermined rest position and a range of active positions where said blade is made to wipe said surface, comprising:
a cartridge containing a solvent-dissolvable surface-treatment material selected from the class consisting of wetting and hydrophobic agents,
said cartridge containing an opening of predetermined size for allowing a solvent applied to said cartridge from a predetermined direction to reach said solvent-dissolvable surface-treatment material in said cartridge,
means for attaching said cartridge to said wiper blade so that when said wiper blade is in said rest position and said solvent is applied to said surface from said predetermined direction, said solvent will not directly fall upon said opening and thereby will not tend to dissolve said solvent-dissolvable surface-treatment material, but when said wiper blade is made to wipe said surface and said solvent is applied to said cartridge from said predetermined direction, said solvent will fall upon said opening, reach, and thereby dissolve said solvent-dissolvable surface-treatment material, so that dissolved solvent-dissolvable surface-treatment material will reach said surface, whereby said surface treatment material will not be subject to ablation unless said wiper blade is in an active position.

2. The device of claim 1 wherein said surface is a vehicle's windshield, said solvent-dissolvable surface-treatment material is water-soluble, and said solvent is rainwater and said direction is generally above said cartridge.

3. The device of claim 1 wherein said cartridge comprises a material selected from the group consisting of metals and plastics.

4. The device of claim 1 wherein said surface treatment material is insoluble in water and said solvent is selected from the group consisting of inorganic, and organic solvents.

5. The device of claim 1 wherein said means for attaching said cartridge to said blade is a clip.

6. The device of claim 1 wherein said cartridge is formed within the structure of a wiper arm or bracket.

7. The device of claim 1 wherein said cartridge is formed within the structure of a wiper blade.

8. The device of claim 1 wherein said cartridge is attached to a channel which holds said wiper blade.

9. A method for applying a surface treatment material to a surface that is wiped with a wiper blade having a predetermined rest position and a range of active positions where said blade is made to wipe said surface, comprising:
providing a cartridge containing a solvent-dissolvable surface-treatment material selected from the class consisting of wetting and hydrophobic agents,
providing an opening of predetermined size in said cartridge for allowing a solvent applied to said cartridge from a predetermined direction to reach said solvent-dissolvable surface-treatment material in said cartridge,
attaching said cartridge to said wiper blade so that when said wiper blade is in said rest position and said solvent is applied to said surface from said predetermined direction, said solvent will not directly fall upon said opening and thereby will not tend to dissolve said solvent-dissolvable surface-treatment material, but when said wiper blade is made to wipe said surface and said solvent is applied to said cartridge from said predetermined direction, said solvent will fall upon said opening, reach, and thereby dissolve said solvent-dissolvable surface-treatment material, so that dissolved solvent-dissolvable surface-treatment material will reach said surface, whereby said surface treatment material will not be subject to ablation unless said wiper blade is in an active position.

10. The method of claim 9 wherein said surface is a vehicle's windshield, said solvent-dissolvable surface-treatment material is water-soluble, and said solvent is rainwater and said direction is generally above said cartridge.

11. The method of claim 9 wherein said cartridge comprises one or more materials selected from the group consisting of metals and plastics.

12. The method of claim 9 wherein said surface treatment material is not soluble in water and said solvent is selected from the group consisting of inorganic, and organic solvents.

13. The method of claim 9 wherein said means for attaching said cartridge to said blade is a clip.

14. The method of claim 9 wherein said cartridge is formed within the structure of a wiper blade.

15. The method of claim 9 wherein said cartridge is attached to a channel which holds said wiper blade.

16. A device for applying a surface treatment material to a surface that is wiped with a wiper blade having a predetermined rest position and a range of active positions where said blade is made to wipe said surface, comprising:
a cartridge containing a solvent-dissolvable surface-treatment material selected from the class consisting of wetting and hydrophobic agents,
said cartridge containing an opening of predetermined size for allowing a solvent applied to said cartridge from a predetermined direction to reach said solvent-dissolvable surface-treatment material in said cartridge,
said cartridge being attached to said wiper blade so that when said wiper blade is in said rest position and said solvent is applied to said surface from said predetermined direction, said solvent will not directly fall upon said opening and thereby will not tend to dissolve said solvent-dissolvable surface-treatment material, but when said wiper blade is made to wipe said surface and said solvent is applied to said cartridge from said predetermined direction, said solvent will fall upon said opening, reach, and thereby dissolve said solvent-dissolvable surface-treatment material, so that dissolved solvent-dissolvable surface-treatment material will reach said surface, whereby said surface treatment material will not be subject to ablation unless said wiper blade is in an active position.

17. The device of claim 16 wherein said surface is a vehicle's windshield, said solvent-dissolvable surface treatment material is water-soluble, and said solvent is rainwater and said direction is generally above said cartridge.

18. The device of claim 16 wherein said cartridge comprises a material selected from the group consisting of metals and plastics.

19. The device of claim 16 wherein said surface treatment material is insoluble in water and said solvent is selected from the group consisting of inorganic, and organic solvents.

20. The device of claim 16 wherein said cartridge is formed within the structure of a wiper blade.
